(19) United States
(12) Patent Application Publication
(10) Pub. No.: US 2026/0062173 A1
(43) Pub. Date: Mar. 5, 2026

(54) Stable Standing Thermo Container

(71) Applicant: maglassX GmbH, Hutthurm (DE)

(72) Inventor: Christoph Fritz, Hutthurm (DE)

(21) Appl. No.: 19/311,339

(22) Filed: Aug. 27, 2025

(30) Foreign Application Priority Data
Aug. 30, 2024 (DE) 102024124941.2

(51) Int. Cl. B65D 23/00; B65D 81/38

(52) U.S. Cl. CPC B65D 23/001; B65D 81/3869

(57) ABSTRACT

Embodiments of the disclosure include a thermo container for temperature-maintaining storage and, in particular, for temperature-maintaining transport of foodstuffs, comprising a container with a receiving chamber for foodstuffs and a lid for closing the thermo container. The container comprises, a central magnet, which is arranged adjacent to its bottom, and which in terms of its magnetic properties, in particular its holding force or magnetic attraction force and its dimensions, is selected, designed, and arranged in accordance with the thermo container such that the thermo container is held by the magnet in a stable, slip-resistant, and stationary manner at a predetermined position, at which a suitable metal element or a suitable metal element is provided, which interacts with the magnet.

### BACKGROUND

The present disclosure relates to a thermo container for temperature-maintaining storage and, in particular, for temperature-maintaining transport of foodstuffs, which is particularly designed to be stable standing. The present disclosure thereby also relates to a system comprising a stable standing thermo container and at least one coaster comprising a metal element or a metal layer that interacts with the thermo container.

Thermo containers are primarily used for transporting foodstuffs, particularly in liquid form, for consumption at a preserved temperature at a later date, while away from home, for example, at work or while traveling. Foodstuffs, beverages, or luxury food items that can be transported in thermo containers include, in particular, soups, hot and cold drinks such as tea, coffee, or soft drinks.

During transport of such thermo containers until the intended consumption of their content, the thermo container and its content should be protected not only from temperature loss but also from any possible unintentional leakage of the content during transport. Therefore, such thermo containers are provided with a suitable lid. If at least part of the content is to be consumed during transport, the lid of the thermo container will naturally be at least partially opened or removed, whereby the thermo container is regularly held by hand, which poses the risk of at least some of the content accidentally leaking out.

### SUMMARY

It is therefore an object of the present disclosure to provide a thermo container for carrying foodstuffs that maintains a desirable temperature for the food, particularly during transportation and transport, and that allows the content of the thermo container to be conveniently and safely consumed during transport of the container. In this connection an object of the present disclosure is, in particular, to provide a stable standing and slip-resistant thermo container that is particularly appropriate for use in a vehicle, as well as to provide a system for the simple and stable positioning of a thermo container.

The object is solved by the features of the independent claims.

Embodiments of the disclosure are mentioned in the subclaims and/or the following description.

An aspect of the disclosure provides a thermo container for temperature-maintaining storage and, in particular, for temperature-maintaining transport of foodstuffs, comprising a container with a food receiving chamber and a lid for closing the thermo container. The container comprises a central magnet adjacent to its bottom, the magnetic properties of which, in particular, its holding force or magnetic attraction force, and its dimensions, are selected, designed, and arranged in accordance with the thermo container such that the thermo container is held by the magnet in a stable standing, slip-resistant, and stationary manner at a predetermined position, at which a suitable metal element or a suitable metal layer is provided, which interacts with the magnet.

The thermo container, which advantageously comprises a magnet, is particularly suitable for carrying and transporting foodstuffs, including liquid food. Even during transport of the thermo container, particularly in a vehicle, the thermo container can be placed in a stable standing, slip-resistant, and fixed position, even when opened. This allows at least some content of the thermo container to be consumed conveniently and safely while carrying and transporting the thermo container.

The bottom of the thermo container may suitably comprise an outer circumferential rim, whereby the magnet can be arranged and configured such that the thermo container, when placed on the floor, rests on the outer rim of the bottom, while the centrally arranged magnet is only minimally spaced from a surface on which the thermo container is placed. The magnet can thus exert its full force of attraction on the metal element or metal layer at the position where the thermo container is placed, such that the thermo container is particularly stable standing and safely placed, even when placed in a vehicle.

To provide the above-mentioned advantageous arrangement of the magnet at the bottom of the thermo container, the bottom comprises a central region for accommodating the magnet, whereby the central region is suitably delimited by an inner rim of the bottom. The magnet can be appropriately flat-cylindrical and advantageously form-fitting to correspond with the central region, and the magnet can be held in the central region by a cover. In this way, the magnet is particularly securely accommodated in the central region at the bottom of the thermo container and protected from contamination and damage, particularly to its surface.

The inner rim of the central region is suitably lower than the outer rim and is surrounded by the outer rim, on which the thermo container stands in a stable, slip-resistant, and stationary manner. Between the inner rim and the outer rim, a groove extends around the inner rim, into which an outer rim of the cover engages, thus providing a particularly reliable coverage of the central region.

To provide the above advantageous properties, the dimensions of the bottom with the central region, the cover, the inner rim and the outer rim are appropriately selected and designed such that the thermo container is resting on the outer rim of the bottom, whereby the magnet of the thermo container is positively accommodated and protected in the central region, and spaced at a predetermined small distance of max. 2 mm and advantageously max. 1 mm from a surface on which the thermo container is placed.

The container of the thermo container can advantageously be made of stainless steel for providing a particularly stable container, and the container can be painted, coated, and/or anodized on the outside. The cover is also suitably made of stainless steel and welded to the inner rim of the central area of the bottom. This ensures that the flat-cylindrical magnet is accommodated particularly securely in the central area and reliably protected. To provide desirable magnetic properties, the magnet is suitably a neodymium magnet.

The receiving chamber of the thermo container can be particularly advantageous for containing foodstuffs in liquid form and beverages. To provide a desirable thermal insulation effect of the receiving chamber, the container can be suitably double-walled and comprise an inner body and an outer body, with a cavity formed between the inner body and the outer body, whereby the cavity can be evacuated. In addition, the inner body of the container can be equipped with a copper coating so that radiant heat from the receiving chamber is reflected by the copper coating.

A central region of the outer body at the bottom of the thermo container, together with the inner rim of the bottom and the cover, suitably forms the central region described above, in which the flat-cylindrical magnet is positively accommodated and protected.

When using the above-mentioned thermo container equipped with a magnet, the thermo container advantageously interacts with a suitable metallic base as described above. In this case, the thermo container can particularly advantageously interact with a suitable coaster, which comprises a metal layer that interacts with the magnet of the thermo container and which is suitably designed as a nano-gel adhesive pad with a slip-resistant, adhesive underside. Such a coaster is particularly advantageous because the coaster allows for advantageous, simple, and flexible refitting of a surface, such as a tray, table, or storage area, even in a vehicle, etc., and enables simple, advantageous, and particularly flexible and reversible, as well as secure and stationary positioning of the thermo container.

An aspect of the disclosure provides relates to a system comprising a thermo container as described above, which is equipped with the magnet, and a coaster corresponding to the magnet, comprising a metal layer interacting with the magnet and which is designed as a nano-gel adhesive pad with a slip-resistant, adhesive underside such that the coaster adheres slip-resistant and stationary at a predetermined position, and thereby interacts with the magnet so that the thermo container is positioned on the coaster in a stable, secure, slip-resistant, and fixed manner.

The system can advantageously comprise a plurality of above mentioned coasters provided for slip-resistant positioning of the thermo container on at least one and advantageously a plurality of positions. The coasters are designed, in particular, to appropriately correspond in their dimensions to the bottom of the thermo container and, in particular, to be comparatively larger than the bottom. Such a system allows particularly simple and flexible handling of the above-described thermo container for many applications, and in particular for a means of transport and/or in a vehicle.

So the thermo container is suitable for many applications and in particular for the safe transport of foodstuffs, especially in liquid form, e.g. on the way to work, to events, when traveling, while camping, etc., whereby the thermo container in particular provides a thermo cup.

A thermo container and a system as described above are particularly suitable for use in conjunction with a suitable means of transport and/or in a vehicle of any type, wherein the magnet is intended for slip-resistant positioning of the thermo container and interacts with a suitable metal element provided on the means of transport or a piece of equipment of a vehicle.

It is clear that a thermo container according to the disclosure is not necessarily limited in its dimensions and, in particular, its storage capacity, and can therefore be freely dimensioned and designed. This also applies to the magnet of the thermo container, which is appropriately designed in accordance with and corresponding to, in particular, the storage capacity of the thermo container.

A particularly advantageous embodiment of a thermo container, particularly designed as a thermo cup for holding liquids, can be advantageously designed to taper conically towards its bottom, particularly for its easy handling, wherein the thermo container can particularly also be designed to hold a liquid volume in the range from 100 ml to 1,500 ml and from 250 ml to 500 ml and particularly from about 300 ml to 350 ml.

Further, in particular technical features and details of such a thermo container, designed as a thermo cup, in particular regarding its dimensions, its magnet with its design, arrangement and in particular also its fastening in the central region of the bottom of the thermo cup, wherein the magnet can also be glued to the central region of the bottom or mechanically clamped or pressed into the central region of the bottom, etc., are described in detail below, in particular with reference to FIG. 6.

As described above, the cover of the magnet and of the central region can be welded to the bottom of the thermo container, and suitably in particular to its inner rim. The cover can also be attached to the bottom in other ways. To ensure a properly stable and secure cover of the magnet, the cover can by example also be welded to the bottom in other ways, or the cover can be soldered to the bottom, or the cover can be glued to the bottom and/or the magnet, or the cover can be securely fastened to the bottom by using appropriate mechanical means.

A system described above, comprising a thermo container and appropriate coasters, can of course also comprise more than one thermo container, whereby the thermo containers can be designed differently, particularly with regard to their dimensions, capacity, and magnets. The coasters suitably have designs appropriate for all thermo containers of the system, particularly with regard to their dimensions and their slip-resistant, adhesive base, designed as a nano-gel adhesive pad, thus providing a system for slip-resistant placement of the differently designed, stable standing thermo containers on predetermined positions.

### BRIEF DESCRIPTION OF THE DRAWINGS

Embodiments of the disclosure are illustrated in the figures and explained in more detail below. In this regard show:

FIG. 1 four representations of a thermo container according to an embodiment of the disclosure, namely a side view, a view looking down on the lid of the thermo container from above, a view with the lid removed, and a view on the bottom of the thermo container;

FIG. 2 an enlarged view of the thermo container of FIG. 1 from below with the central cover of the bottom removed together with a magnet according to an embodiment of the disclosure;

FIG. 3 a longitudinal sectional view of a thermo container of according to the disclosure without its lid together with a magnet and a cover appropriate for the bottom of the thermo container;

FIG. 4 the thermo container assembled according to embodiments of the disclosure;

FIG. 5 the thermo container according to embodiments of the disclosure together with coasters appropriate for such a thermo container;

FIG. 6 another representation of a thermo container according to embodiments of the disclosure;

FIG. 7 the thermo container according to embodiments of the disclosure together with a thermo container according to a further embodiment of the disclosure, and together with coasters appropriate for such thermo containers.

The figures may comprise partly simplified, schematic illustrations. To some extent, identical designations are used for elements which are the same but possibly not identical. Different views of the same elements could be scaled differently. Not all reference symbols are shown in all figures.

### DETAILED DESCRIPTION

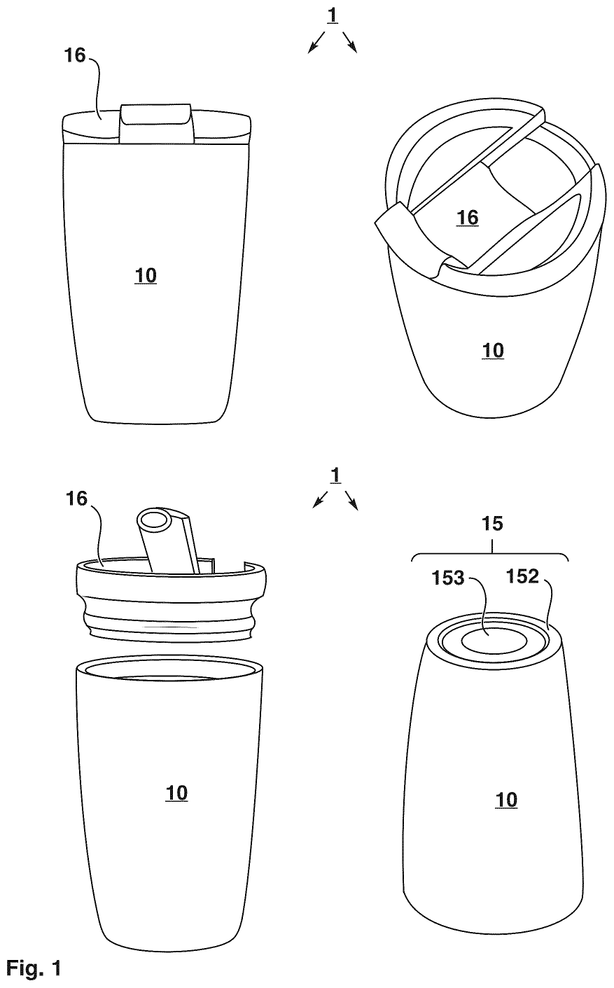

FIG. 1 shows four representations of a thermo container 1 according to an embodiment of the disclosure with the container 10, namely a side view of the container 10, a view looking down on the lid 16 of the thermo container 1 from above, a view with the lid 16 removed and a view on the bottom 15 of the thermo container 1.

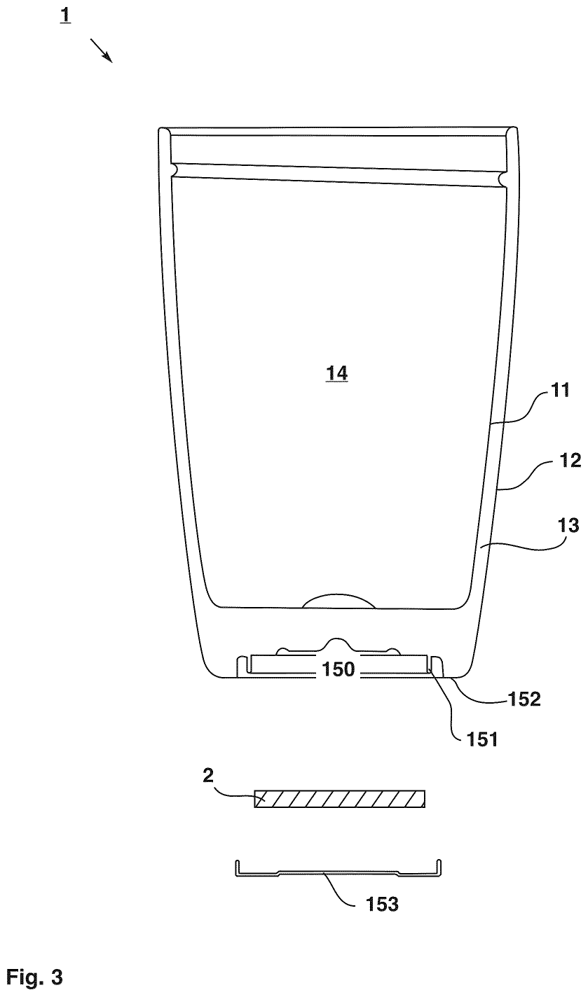

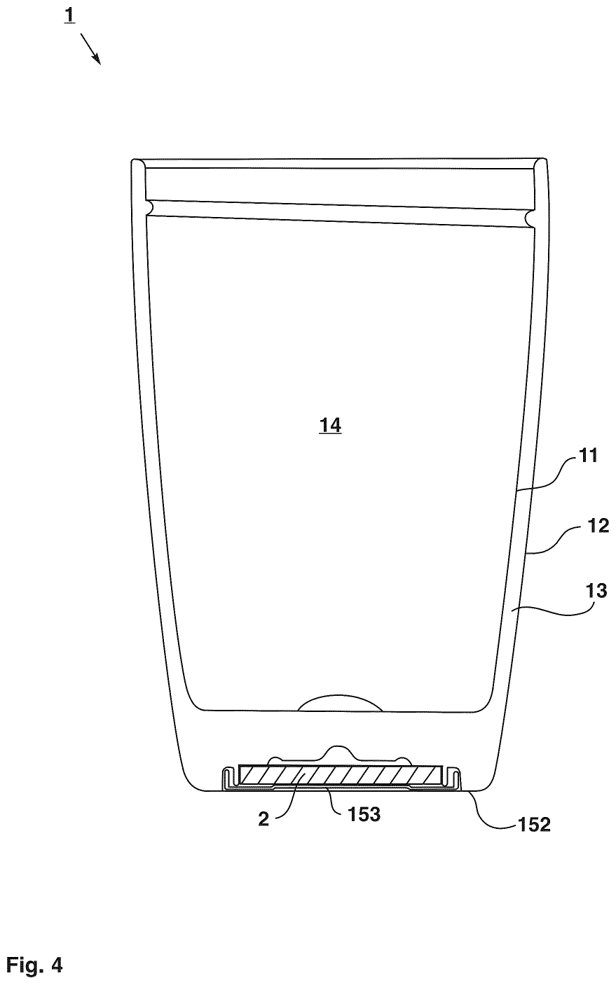

The thermo container 1 is primarily intended for carrying foodstuffs, particularly those that are largely in liquid form, in order to consume them at a later time while away from home, for example at work or while traveling, at a preserved temperature, whereby in particular a thermo cup 1 is provided with the thermo container 1. The thermo container 1 is designed with the container 10 made of a suitable stainless steel material, as described below in particular with reference to FIG. 3 and FIG. 4. The container 10 made of a stainless steel material of the embodiment shown in FIG. 1 is painted on the outside.

The thermo container 1 comprises an upper lid 16 by means of which the thermo container 1 can be closed and which is designed such that the lid 16 can also be opened only partially, for example to extract a liquid.

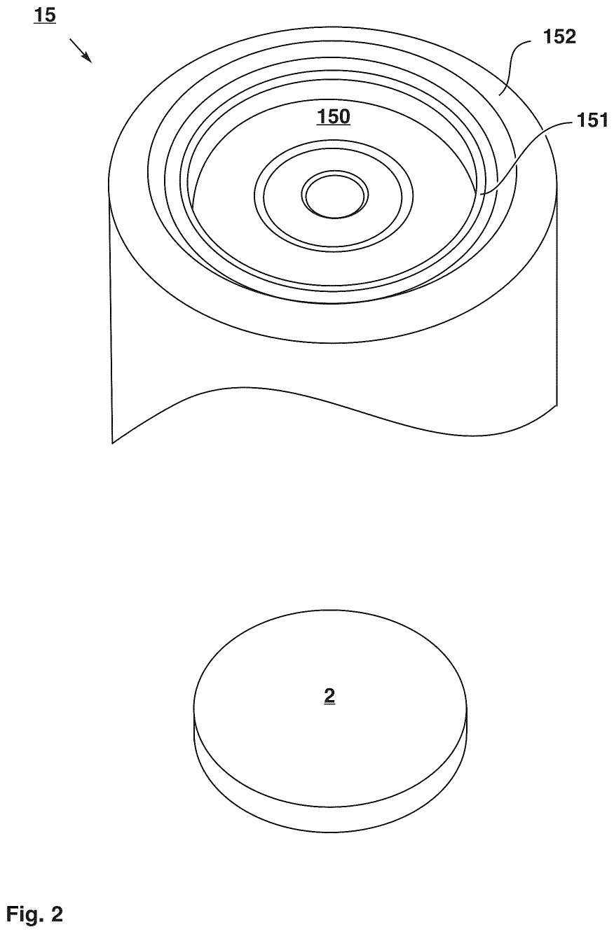

The bottom 15 of the container 10 comprises a circumferential outer rim 152 on which the erected thermo container 1 stands. In addition the bottom 15 comprises a central cover 153, which is suitably also made of a stainless steel material, and which covers an advantageous central magnet 2 accommodated in a central region 150 of the bottom 15. In this regard, reference is also made to the following description, particularly with reference to FIG. 2, FIG. 3, and FIG. 4.

The central magnet 2 is selected, designed and arranged in its magnetic properties, in particular its holding force or its magnetic attraction force and its dimensions, in accordance with the thermo container 1 such that the thermo container 1 is held slip-resistant and stationary by the magnet 2 at a predetermined position P, P1, P2, at which an appropriate metal element or an appropriate metal layer is provided which interacts with the magnet 2.

The thermo container 1, which advantageously comprises a magnet 2 in its bottom 15, provides a stable standing and slip-resistant thermo container 1 and, in particular, a thermo cup 1 that is suitable for many applications, particularly for the safe transport of foodstuffs, especially in liquid form, e.g., on the way to work, to events, while travelling and on camping, etc. Thus the thermo container 1 is particularly advantageous for use in a vehicle. The magnet 2 can, in particular, advantageously be provided by a neodymium magnet 2.

FIG. 2 shows an enlarged view of the thermo container 1 of FIG. 1 from below with the central cover 153 of the bottom 15 removed together with a magnet 2 according to an embodiment. For the sake of clarity, the flat-cylindrical magnet 2 is shown outside the central region 150 that accommodates it. For this purpose, the magnet 2 is advantageously designed to correspond in a form-fitting manner to the central region 150, which is delimited by an inner rim 151.

The inner rim 151 is surrounded by the above-described outer rim 152, on which the erected thermo container 1 stands. The inner rim 151 is correspondingly lower than the outer rim 152. Between the inner rim 151 and the outer rim 152, a groove extends surrounding the inner rim 151, into which an outer rim of the cover 153 described above with reference to FIG. 1 engages. For a stable, secure, and protected arrangement and accommodation of the magnet 2 in the central region 150, the cover 153 is advantageously welded to the inner rim 151 of the central region 150. The cover 153, like the container 10 and accordingly also its bottom 15, is provided from a stainless steel material.

In the center of the inner central region 150, adjacent to the magnet 2, there is arranged a suction opening which is sealed by material bonding after the manufacture of the thermo container 1 for evacuating a cavity 13 of the container 10 and providing its thermal insulating properties, which is described below with reference to FIG. 3 and FIG. 4.

FIG. 3 shows a longitudinal sectional view of the container part 10 of the thermo container 1 of FIG. 1 together with the magnet 2 and the cover 153 appropriately adapted for the bottom 15 of the thermo container 1 and for the magnet 2 in their individual components, and FIG. 4 shows the container 10 of the thermo container 1 of FIG. 3 assembled as intended.

The container 10 of the thermo container 1 comprises a receiving chamber 14, which is particularly suitable for receiving foodstuffs in liquid form and beverages. To provide a desirable thermal insulation effect of the receiving chamber 14, the container 10 is double-walled comprising an inner body 11 and an outer body 12, with a cavity 13 formed between the inner body 11 and the outer body 12. The cavity 13 is, for example, evacuated, and a getter can also be arranged therein for maintaining the vacuum in the cavity 25 over a long service life of the thermo container 1.

As described above, the container 10 of the thermo container 1 is made of stainless steel, and is suitably manufactured by a deep drawing process. The exterior of the container 10 is suitably painted. The inner body 11 of the container 10 is advantageously equipped with a copper coating so that radiant heat from the receiving chamber 14 is reflected by the copper coating, thereby keeping hot liquids or foodstuffs contained in the receiving chamber 14 hot for even longer. The same applies to chilled liquids or foodstuffs.

For creating the vacuum in the cavity 13, an area at the bottom 15 of the container 10 comprises a suction opening through which the cavity 13 can be evacuated in order to thereafter seal the suction opening in a material-locking manner, while the vacuum in the cavity 13 is maintained.

To connect the inner body 11 and the outer body 12 of the container 10, a circumferential fabric seam is provided along the upper outer edge. This seam is carefully finished, since the circumferential edge in the area of the fabric seam also forms a drinking edge, especially when the contents of the container 10 are to be drunk directly from it. The fabric seam can, for example, comprise a welded seam or a soldered joint.

As described above, the magnet 2 is formed as a flat cylinder, positively corresponding to the central region 150 in the bottom 15 of the thermo container 1. The cover 153 comprises an outer rim 152 with which it surrounds the inner rim 151 surrounding the central region 150. After assembly and welding to the inner rim 151 of the bottom 15, whereby the magnet 2 being positively accommodated in the central region 150, the rim of the cover 153 is arranged adjacent to the outer rim 152 on which the erected thermo container 1 stands. It is clear that the cover 153 can also be soldered to the bottom 15.

The dimensions of the cover 153, the inner rim 151, and the outer rim 152 are advantageously selected such that the magnet 2, accommodated in the central region 150 of the thermo container 1, is spaced at a predetermined short distance of max. 2 mm, and advantageously max. 1 mm, from a base surface on which the thermo container 1 resting on the outer rim 152 of the bottom 15 is placed. As a consequence, the magnet is spaced a short distance from a metal element M on the surface and can exert its full force of attraction, so that the thermo container 1 is advantageously positioned in a stable standing and slip-resistant manner.

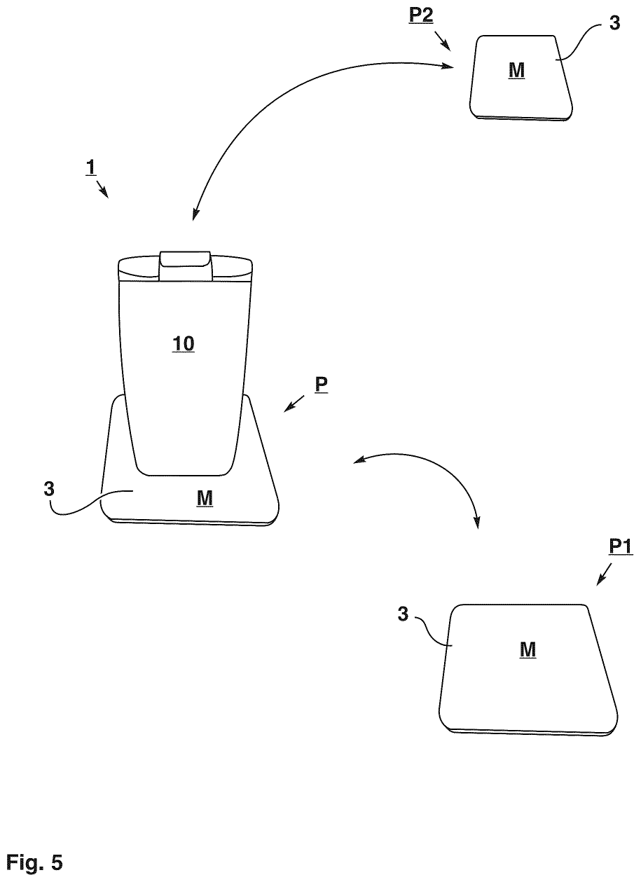

FIG. 5 shows the thermo container 1 of FIG. 1 together with coasters 3 appropriate for the thermo container 1 and in particular for its stable standing and slip-resistant positioning.

The flat coaster 3 is suitably a nano-gel adhesive pad with a slip-resistant and adhesive underside. The coaster 3 comprises a metal layer M that interacts with the magnet 2 of the thermo container 1. Thus the coaster 3 is suitably designed with its slip-resistant and adhesive underside so that it can be easily and flexibly placed at a predetermined position P, P1, P2 on a surface, e.g., of a piece of furniture such as a table, a storage area or a shelf, after which the coaster 3 is positioned in a slip-resistant and adhesive manner and at the same time reversibly for its intended use in cooperation with the thermo container 1. The coaster 3 of FIG. 5, on which the thermo container 1 is placed, suitably has a surface that corresponds to the dimensions of the bottom 15 and which is thereby comparatively larger than the bottom 15.

The thermo container 1 placed on the coaster 3 interacts with its magnet 2 as intended with the coaster 3 comprising a metal layer M in such a way that the thermo container 1 is held stable standing and slip-resistant on the coaster 3.

The coaster 3, which interacts with the magnet 2 of the thermo container 1, is arranged with its underside adhering slip-resistant at a predetermined position P, P1, or P2. In FIG. 5, two further exemplary positions P1 and P2 are schematically shown in addition to the aforementioned coaster 3 at position P. As already mentioned above, the positions P, P1, and P2 can each represent a predetermined position P, P1, P2 on a surface, e.g., of a piece of furniture, such as a table or shelf or a storage area, particularly in a vehicle.

Thus a system 1, 2, 3 for slip-resistant positioning of the stable standing thermo container 1 on at least one predetermined position P, P1, P2 is provided, comprising a stable standing thermo container 1, the bottom 15 of which comprising a central magnet 2, and at least one coaster 3 that interacts with the thermo container 1, whereby the coaster 3 comprises a metal layer M that interacts with the magnet 2 and whereby the coaster 3 is designed as a nano-gel adhesive pad with a slip-resistant and adhesive base. The system 1, 2, 3 can advantageously comprise a plurality of coasters 3, each of which being provided for the stable standing and slip-resistant positioning of the thermo container 1 at a plurality of positions P, P1, P2.

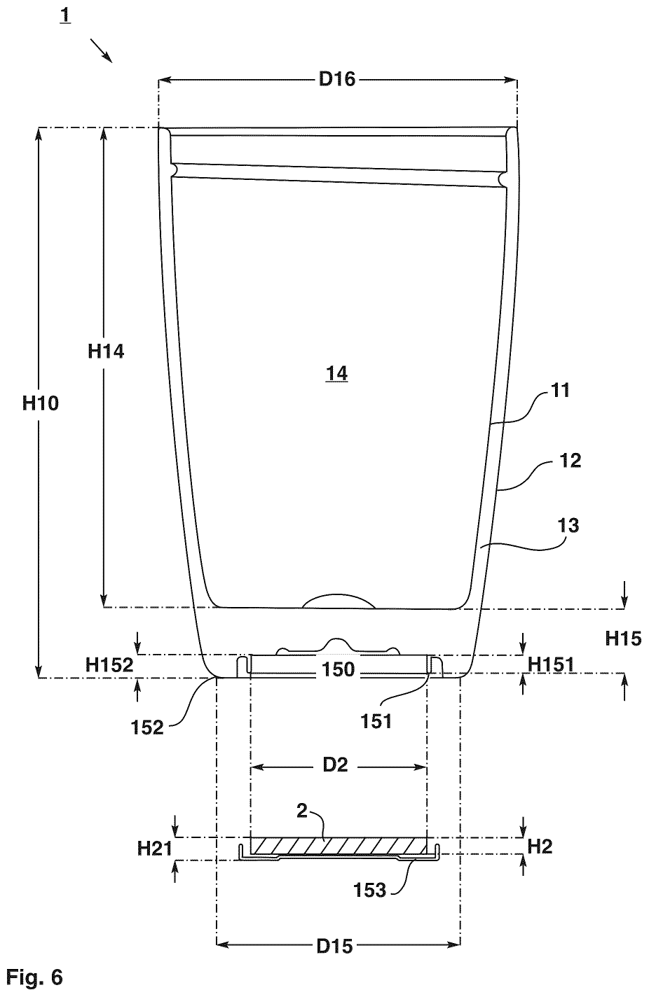

FIG. 6 shows a further representation of the thermo container 1 from FIGS. 3 and 4, wherein measurements and dimensions and in particular also its storage capacity for a thermo container 1 designed as a safe and easy-to-handle thermo cup 1 are described below with reference to FIG. 6. It should be noted again at this point that the advantageous embodiment of a thermo container 1 described below with reference to FIG. 6 represents an embodiment. As already mentioned above, a thermo container 1 according to some embodiments are not limited in its measurements and dimensions and in particular in its storage capacity and can accordingly be dimensioned and designed as desired.

For a better understanding, in particular a form and arrangement of the magnet 2 in the central region 150 of the bottom 15, and a configuration of the thermo container 1 as a thermo cup 1, which is particularly appropriate for the safe transport of foodstuffs in liquid form and also their consumption directly from the thermo cup 1, FIG. 6 shows a further illustration of the thermo container 1 from FIGS. 3 and 4, also in a longitudinal sectional view. For the sake of clarity and transparency and for better understanding, as in FIGS. 3 and 4, only the magnet 2 is shown hatched in FIG. 6.

In the exploded view of FIG. 3, as can be seen and described above, the magnet 2 is shown outside and oppositely spaced from the central region 150 of the bottom 15 and also spaced from the cover 153. In FIG. 4, the magnet 2 of the assembled container 10 is arranged as intended in the central region 150 and covered by the cover 153. For a better understanding, FIG. 6, in a view of FIGS. 3 and 4 together, shows the magnet 2 as in FIG. 3 outside and oppositely spaced from the central region 150 of the bottom 15, wherein the cover 153 is shown adjacent to and in intended contact with the magnet 2, which corresponds to their relative arrangement in FIG. 4.

Thus, in FIG. 6 it is shown more clearly that the cover 153, as already shown schematically in FIG. 1, comprises a central slightly stepped area which, in the representation of the assembled container 10 of FIG. 4, is in contact with the magnet 2. In this arrangement, an annular peripheral region of the cover 153 surrounding this slightly stepped central region is adjacent to its outer rim, which surrounds the inner rim 151 surrounding the central region 150, and is slightly spaced from the magnet 2 of the container 10 assembled as intended.

The central region 150 of the bottom 15 has, adjacent to the inner rim 151, a flat annular region which surrounds the above-described materially bonded and sealed suction opening in the center of the inner central region 150. Thereby the suction opening forms an indentation relative to the above mentioned, flat annular region of the central region 150. Thereby the magnet 2, which is positively arranged in the central region 150, is arranged, as shown in FIGS. 4 and 6, adjacent to this flat annular region of the central region 150, and adjacent to the inner rim 151 and adjacent to the slightly stepped central region of the cover 153 described above. The magnet 2, which is thus appropriately arranged in the central region 150, is spaced from the bottom of the central sealed suction opening and, as described above, the magnet 2 is also slightly spaced from the annular peripheral region of the cover 153.

For providing a particularly stable and secure positioning and covering of the magnet 2 in the central region 150, the magnet 2 can be glued completely or selectively to the central region 150 of the bottom 15 and also to the annular region of the cover 153, in particular in the region of the flat annular region surrounding the central sealed suction opening, by means of a suitable, in particular temperature-resistant, liquid adhesive or a suitable, in particular double-sided adhesive tape or double-sided adhesive pads. An appropriate liquid adhesive can be selected, for example, based on a polymer-modified silane (MS polymer-based). The indented area around the central sealed suction opening can thus be completely filled with a liquid adhesive or completely covered with a suitable adhesive tape or adhesive pad. The magnet 2 can also be mechanically clamped into the central region 150 of the bottom 15 or inserted into the central region 150 and pressed laterally or screwed to the bottom 15 in the central region 150 of the bottom 15, which can be appropriately designed for this purpose.

Appropriate dimensions of the flat-cylindrical magnet 2 correspond to the dimensions of the central region 150, whose diameter substantially corresponds to the diameter D2 of the magnet 2. The inner rim 151 surrounding the central region 150 has a height H151 that is comparatively smaller than the height H152 of the outer rim 152 on which the erected thermo container 1 stands. The height H2 of the cylindrical magnet 2 is thereby selected to be smaller than the height H151 of the inner rim 151 such that the height H21 of the magnet 2 accommodated in the central region 150 and equipped with the cover 153 is slightly topped by the outer rim 152, as described above. The magnet 2 accommodated in the central region 150 of the thermo container 1 resting on the outer rim 152 of the bottom 15 is thereby spaced at a predetermined small distance of max. 2 mm, and advantageously, max. 1 mm from a surface on which the thermo container 1 is placed. In this way, the magnet 2 is spaced at a short distance from a metal element M on the surface and can thus exert its full attractive force, so that the thermo container 1 is advantageously positioned in a stable standing and slip-resistant manner.

The thermo container 1, which is advantageously designed as a thermo cup 1 as also described above and which is particularly suitable for liquids, can advantageously have, for its simple and convenient handling, an upper opening which is comparatively large to the bottom 15 of the container 10 and whose diameter D16 is larger than the diameter D15 of the bottom 15 by a predetermined amount. The thermo cup 1 is thus substantially conically tapered from its upper edge to the bottom 15 and is therefore particularly easy and convenient to handle, in particular for drinking a liquid directly from the upper opening when the lid 16 is removed or opened.

An above described thermo container 1 advantageously designed as a thermo cup 1 can be appropriately dimensioned with the diameter D16 of its upper opening, the diameter D15 of its bottom 15 and in particular also the height H10 of its container 10 such that a filling volume capacity of its receiving chamber 14 is suitably in the range of 250 ml to 500 ml and, for a desirably simple handling, in particular around 300 ml to 350 ml. A thermo container 1 designed for an advantageous filling volume capacity in the range of about 350 ml and advantageously designed as a conically tapered thermo cup 1 can have a diameter D16 of its upper opening of about 80 mm, a height H14 of its receiving chamber 14 of about 110 mm, a height H10 of its container 10 of about 125 mm and a diameter D15 of its bottom 15 of about 60 mm.

Thus the bottom 15 of the thermo container 1 has a height H15 of suitably approximately 15 mm. A magnet 2 appropriate for providing the above-described stable standing and slip-resistant properties for a thermo container 1 designed as a thermo cup 1 and configured for a filling volume capacity in the range of 350 ml, with correspondingly effective magnetic properties, can suitably be advantageously designed as a flat cylinder with a diameter D2 of approximately 40 mm and a height H2 of approximately 4 mm. For the positive accommodation of the magnet 2 in the bottom 15, the diameter of the central region 150 and the height H151 of the inner rim 151 surrounding the central region 150 suitably correspond to the diameter D2 and the height H2 of the magnet 2, respectively.

A thermo container 1 described above, appropriately adapted as a thermo cup 1, is designed with its dimensions, in particular also of its magnet 2, for a desirable filling volume capacity in the range of 350 ml. Thermo containers 1 designed for a larger filling volume capacity in the range of, for example 500 ml to for example 1,200 ml are appropriately adapted, shaped, and/or otherwise dimensioned. Such correspondingly larger thermo containers 1, which have a correspondingly greater weight, in particular when filled, can, in order to provide the above-described stable standing and slip-resistant properties, in particular include a magnet 2 with correspondingly selected, suitably strong magnetic properties, wherein the magnet 2 also has a diameter D2 and a height H2 with appropriate dimensions. Corresponding to the magnet 2 this obviously also applies to the bottom 15 of the container 10 with in particular the central region 150 and the cover 153.

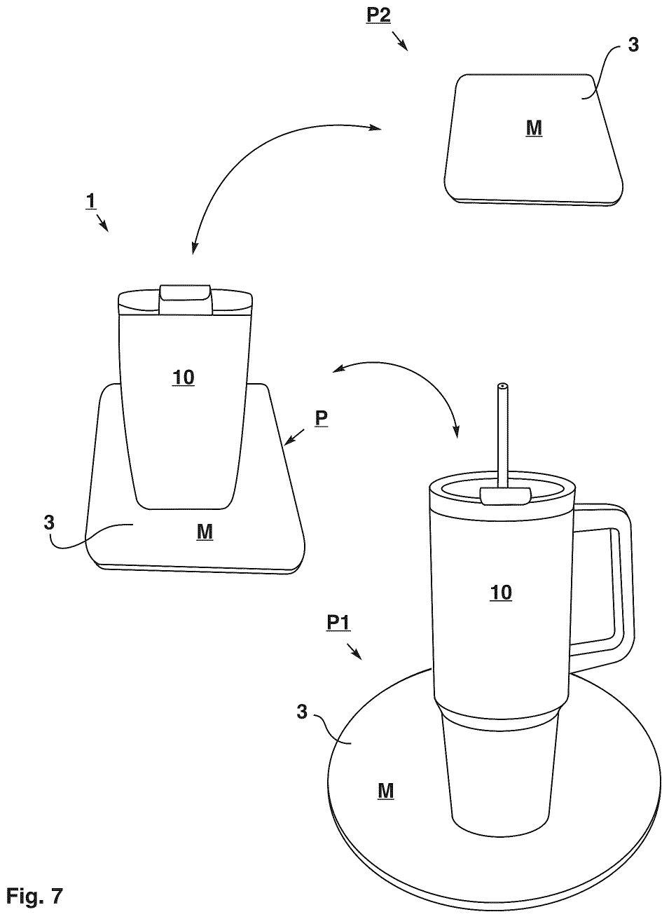

FIG. 7 shows the thermo container 1 of FIG. 1 together with a thermo container 1 according to a further embodiment and together with for the thermo containers 1 appropriate coasters 3.

As described above with reference to FIG. 5, a system 1, 2, 3 is provided for slip-resistant placement of the stable standing thermo cup 1 in at least one predetermined position P, P1, P2, the system 1, 2, 3 comprising at least one stable standing thermo container 1, the bottom 15 of which comprising a central magnet 2, and at least one coaster 3 which interacts with the thermo container 1, whereby the coaster 3 comprises a metal layer M which interacts with the magnet 2, and whereby the coaster 3 is designed as a nano-gel adhesive pad with a slip-resistant and adhesive base.

The system 1, 2, 3 can advantageously comprise a plurality of coasters 3 and also a plurality of thermo containers 1, wherein the coasters 3 are each provided and appropriately designed for the stable and slip-resistant positioning of the thermo containers 1 at a plurality of positions P, P1, P2. The thermo container 1 shown on the left in FIG. 7 corresponds to the thermo cup 1, which is designed in a conical shape tapering towards its bottom 15, described above with reference to FIG. 1, and in particular, also FIGS. 3, 4 and 6, whereby the thermo cup 1 is adapted for a capacity of holding a liquid of 350 ml. The additional, comparatively larger thermo container 1 placed on the circular coaster 3 is adapted for a capacity to hold, for example, a liquid volume of 500 ml, whereby the thermo container 1 is also suitably tapered towards its bottom 15. The larger thermo container 1 comprises an upper section with a handle for easy handling of the thermo container 1. Between the upper section of the thermo container 1 and its lower section, a narrow section is formed below the handle, in which the thermo container 1 tapers particularly sharply.

As described above, in particular with reference to FIG. 6, the larger thermo container 1 comprises an adapted magnet 2 having an appropriate, comparatively strong magnetic attraction force and which in particular can also have correspondingly adapted dimensions. For a stable, slip-resistant and safe standing of the thermo container 1, the coasters 3 of the system 1, 2, 3 of FIG. 7 which are adapted to the thermo container 1 are designed in particular with their nano-gel adhesive pad with a slip-resistant and adhesive base and also their dimensions corresponding to the larger thermo container 1, and therefore the coasters 3 of course also continue to be suitable for the smaller thermo container 1.

Although various aspects or features are shown in combination in the figures, it will be apparent to those skilled in the art—unless otherwise stated—that the illustrated and discussed combinations are not the only possible ones. In particular, corresponding units or feature combinations from different embodiments can be interchanged.

What is claimed is:

1. A thermo container for temperature-maintaining storage and transport of foodstuffs, comprising:
a container with a receiving chamber for foodstuffs; and
a lid for closing the thermo container,
wherein the container includes a central magnet adjacent to a bottom, and wherein the magnet is configured to hold the thermo container in a stable standing and stationary manner at a predetermined position, at which a metal element is provided, and in which the metal element interacts with the magnet.

2. The thermo container according to claim 1, wherein the bottom comprises an outer circumferential rim, and the magnet is arranged and configured such that the thermo container erected on the bottom rests on the outer rim, while the centrally arranged magnet is spaced having a predetermined short distance from a surface on which the thermo container is placed.

3. The thermo container according to claim 2, wherein the magnet is flat-cylindrical, and the bottom includes a central region for accommodating the magnet, which is delimited by an inner rim, wherein the magnet is configured to correspond in a form-fitting manner to the central region and is held and protected by a cover in the central region.

4. The thermo container according to claim 3, wherein the inner rim is lower than the outer rim and is surrounded by the outer rim on which the placed thermo container stands, and wherein a groove extends around the inner rim between the inner rim and the outer rim, into which the groove an outer rim of the cover engages.

5. The thermo container according to claim 3, wherein the dimensions of the bottom with the central region, the cover, the inner rim, and the outer rim are selected and configured such that the magnet is positively accommodated in the central region of the thermo container which rests on the outer rim of the bottom, whereby the magnet is spaced between approximately 1-2 mm from the surface on which the thermo container is placed.

6. The thermo container according to claim 3, wherein the container of the thermo container includes a stainless steel material, is at least one of painted, coated, or anodized on an outside surface, the cover is made of a stainless steel material, and the magnet is a neodymium magnet.

7. The thermo container according to claim 3, wherein the cover is fastened to the bottom by at least one of, a weld, a solder, or glue.

8. The thermo container according to claim 7, wherein the cover is welded to the inner rim of the central region of the bottom.

9. The thermo container according to claim 3, wherein the magnet is adhesively coupled to the central region of the bottom, is mechanically clamped or pressed into the central region of the bottom, or is screwed to the bottom in the central region of the bottom.

10. The thermo container according to claim 1, wherein the receiving chamber of the container is configured to receive foodstuffs in liquid form, and wherein a thermo cup is provided by the thermo container,
wherein to provide a thermal insulation effect of the receiving chamber, the container includes an inner body and an outer body, wherein a cavity is formed between the inner body and the outer body, whereby the cavity is evacuated.

11. The thermo container according to claim 10, wherein the thermo container is tapered conically towards its bottom.

12. The thermo container according to claim 10, wherein the receiving chamber of the thermo container is designed to accommodate a liquid volume in the range of approximately 100 ml to 1,500 ml.

13. The thermo container according to claim 10, wherein the receiving chamber of the thermo container is designed to accommodate a liquid volume in the range of approximately 250 ml to 500 ml.

14. The thermo container according to claim 10, wherein the receiving chamber of the thermo container is designed to accommodate a liquid volume in the range of approximately 200 ml to 350 ml.

15. The thermo container according to claim 10, wherein the inner body of the container includes a copper coating so that radiant heat from the receiving chamber is reflected by the copper coating.

16. The thermo container according to claim 10, wherein a central region of the outer body at the bottom of the thermo container, together with the inner rim and the cover, forms the central region in which the magnet, having a flat-cylindrical design, is positively accommodated.

17. A system comprising a thermo container according to claim 1, and at least one coaster corresponding to the thermo container and the magnet, wherein:
the coaster includes a metal element that interacts with the magnet and whereby the coaster is designed as a nano-gel adhesive pad with an adhesive underside, such that the coaster adheres to a surface in a stationary manner at a predetermined position, and
the coaster interacts with the magnet such that the thermo container placed on the coaster is positioned in a stable standing and stationary manner.

18. The system according to claim 17, wherein the thermo container is at least two thermo containers, and the at least two thermo containers have different filling volume capacities and different sized magnets.
